(19) United States
(12) Patent Application Publication
(10) Pub. No.: US 2002/0057531 A1
(43) Pub. Date: May 16, 2002

(54) HGA ballbond assembly with wafer process assembly features

(75) Inventors: Richard L. Segar, Eagan, MN (US); Jumna P. Ramdular, Brooklyn Park, MN (US); Ruperta T. Randular, Brooklyn Park, CA (US); Paul E. Gallup, New Hope, MN (US); John A. Rice, Long Lake, MN (US); Richard P. Larson, Brooklyn Park, MN (US); Michael J. Gronseth, Bloomington, MN (US); Gordon M. Jones, Eagan, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Seagate Technology LLC, Scotts Valley, CA

(21) Appl. No.: 10/010,169

(22) Filed: Nov. 13, 2001

Related U.S. Application Data
(60) Provisional application No. 60/249,081, filed on Nov. 15, 2000.

(51) Int. Cl. G11B 5/60

(52) U.S. Cl. 360/234.5

(57) ABSTRACT

A method is used for aligning a slider on a gimbal. The gimbal includes a slider opposing face with a flex circuit material on the slider opposing face and a flex on suspension (FOS) bond pad is disposed on the flex circuit material. The slider has a gimbal opposing face and a disc opposing face. Both faces are bounded by a leading edge and a trailing edge. The slider has a forward face along the trailing edge extending between the gimbal opposing face and the disc opposing face. An extended bond pad is formed on the forward face of the slider. A notch is formed on the slider in the forward face adjacent the gimbal opposing face. The slider is placed on the flex circuit material such that the extended bond pad is positioned relative to the FOS bond pad to improve bond strength and static attitude.

### CROSS-REFERENCE TO RELATED APPLICATION(S)

This application claims priority from provisional application No. 60/249,081 filed Nov. 15, 2000, for “HGA BALLBOND ASSEMBLY WITH WAFER PROCESS ASSEMBLY FEATURES” by Richard L. Segar, Jumna P. Ramdular, Paul Gallup, John A. Rice, Richard P. Larson and Michael J. Gronseth.

### BACKGROUND OF THE INVENTION

The present invention relates to aligning a slider to a gimbal of a suspension assembly. More particularly it relates to mechanical features of the slider that improve alignment capabilities of the slider.

Air bearing sliders have been extensively used in disc drives to appropriately position a transducing head above a rotating disc. The transducing head is typically carried by the slider. Conventionally, head positioning is accomplished by operating an actuator arm with a large-scale actuation motor, such as a voice coil motor (VCM), to radially position the slider over a track on a disc. Typically, disc drive systems include a suspension assembly attached to the actuator arm for supporting and positioning the slider. The suspension assembly includes a load beam attached to the actuator arm and a gimbal disposed at the opposite end of the load beam. A flex circuit material is deposited on the gimbal and the actuator arm. The air bearing slider carrying the transducing head is mounted to the flex circuit material. This type of suspension assembly is used with both magnetic and nonmagnetic discs. The VCM rotates the actuator arm and the suspension assembly to position the transducing head over a desired radial track of the disc.

In order for the disc drive to read and write data from the transducing head, conductive traces are disposed along the flex circuit material of the suspension assembly for the disc drive to electrically communicate with the slider. The traces extend along the gimbal and end at flex on suspension (FOS) bond pads formed adjacent to the slider. The slider has a forward face with bond pads disposed on the forward face such that an electrical connection can be made between the traces and the slider. Typically gold ball bonds are used to provide the connection between the FOS bond pads and the slider bond pads. Difficulties have arisen in prior art systems for attaching the slider to the gimbal, and in particular with respect to aligning the slider bond pads to the FOS bond pads.

Several factors affect slider alignment to the FOS bond pads. These factors include flex circuit material alignment to the gimbal, slider alignment to the gimbal, the dimensional features of the gimbal, slider and flex circuit material, and the method of assembly. Slight variations in each of these combine to form a tolerance stack-up, which is the addition of variations that occur during the assembly of the suspension assembly. A poor suspension assembly design fails when the variations are extreme.

Head gimbal assembly (HGA) manufacturers have implemented automation as a means for reducing labor and overhead costs. The ball bond interconnect design has been accepted by most disc drive manufacturers as a manufacturing process capable of being automated and a solution for electrically connecting the slider to the gimbal and the conductive traces. The ball bond HGA design requires that the slider be placed in close proximity to the FOS bond pads. Furthermore, some HGA manufacturers purchase preassembled gimbals where the flex circuit material is already deposited onto the gimbal. Due to limitations in the manufacturing process, the location of the FOS bond pads may change slightly from assembly to assembly so that the precise location of the bond pads is difficult to predict. The FOS bond pad strength may be reduced as well. The unpredictability of the FOS bond pad locations make proper alignment of the slider on the gimbal more difficult, so that the likelihood of the slider bond pads aligning with the FOS bond pads decreases. As a result, the slider ends up too far away or too far forward of the FOS bond pads.

If the slider is too far away from the FOS bond pads, a too large gap occurs between the slider bond pads and the FOS bond pads. A too large gap results in a low contact area between the ball and the bond pads, therefore a weak interconnect or no connection occurs between the slider bond pad and the FOS bond pad. A weak interconnect leads to an increased potential failure mode of the electrical connection between the slider bond pads and the FOS bond pads.

If the slider is too far forward the slider overlaps the FOS bond pads. An overlapping assembly will result in a low slider-to-gimbal bond strength and a large pitch static attitude shift.

Pitch static attitude is the angle of the slider air bearing surface in relation to the baseplate of the suspension. Static attitude impacts fly height, take off velocity in the prior art system and the reliability of the head disc interface. The increased pitch of the slider due to misalignment described above results in a non planar air bearing and causes increased fly height variability. When the slider is not attached to the gimbal with the required static attitude, a post assembly adjustment must be done to change the static attitude at an additional cost and with detrimental effects to other suspension characteristics.

Typically, the slider is placed on the gimbal with respect to a load point on the load beam. The load beam has a dimple located at its distal end which serves as the load point. The gimbal is attached to the load beam such that it balances about the dimple and the flex circuit is attached to the gimbal so that the flex circuit is centered relative to the dimple. Placing the slider with respect to the dimple minimizes the degradation of the slider's fly height above the disc. However, by placing the slider on the gimbal with respect to the dimple, the slider bond pads are often either too far away or too far forward of the FOS bond pads. It results in an increased tolerance stack up of the slider with respect to the FOS bond pads.

A slider design is needed in the art that improves the alignment between the slider and the dimple on the load beam in a manner that provides a strong interconnect between the FOS bond pads and the slider bond pads, results in a high slider to gimbal bond strength, a small pitch static attitude shift, and provides a tolerance buffer which allows the slider to be placed relative to the suspension assembly load point without degrading mechanical structure.

### BRIEF SUMMARY OF THE INVENTION

The present invention is a method for aligning a slider on a gimbal. The gimbal includes a slider opposing face. The gimbal has flex circuit material on the slider opposing face and a FOS bond pad disposed on the flex circuit material. The slider has a gimbal opposing face and a disc opposing face. Both faces are bound by a leading edge and a trailing edge. The slider has a forward face along the trailing edge extending between the gimbal opposing face and the disc opposing face. An extended bond pad is formed on the forward face of the slider. A notch is formed on the slider at the forward face adjacent to the gimbal opposing face. The slider is placed on the flex circuit material of the gimbal, and the extended bond pad and the notch provide additional assembly margin relative to the FOS bond pad to improve bond strength and static attitude.

### BRIEF DESCRIPTION OF THE DRAWINGS

FIG. 1 shows a top perspective view of a disc drive actuation system for positioning a slider over tracks of a disc.

FIG. 2 shows a portion of the disc drive actuation system.

FIG. 3 shows an exploded perspective view of a distal portion of the disc drive actuation system of FIG. 1.

FIG. 4 shows a bottom perspective view of the distal end portion of the disc drive actuation system of FIG. 2.

FIG. 5 is a perspective view of a slider and bond pads.

FIG. 6A is a cross-sectional view of one embodiment of the slider attached to the gimbal.

FIG. 6B is a schematic diagram of the distal portion of the disc drive actuation system.

FIG. 7 is a cross-sectional view of another embodiment of the slider attached to the gimbal.

FIG. 8 through FIG. 15 show a side view of the slider illustrating various stages of the manufacturing process.

### DETAILED DESCRIPTION

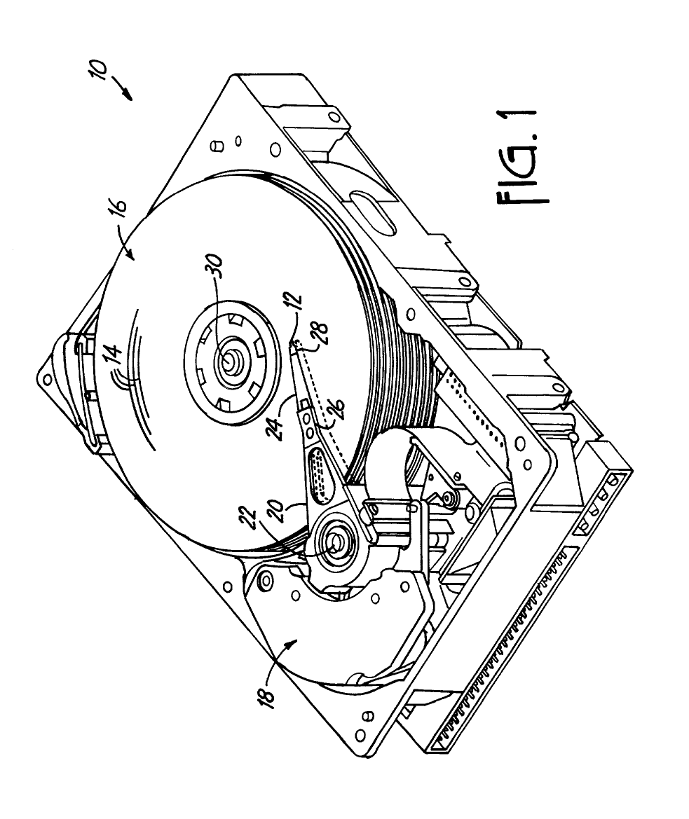

FIG. 1 is a perspective view of a disc drive 10 including an actuation assembly for positioning a slider 12 over a track 14 of a disc 16. Disc drive 10 includes a voice coil motor (VCM) 18 arranged to rotate an actuator arm 20 on a spindle around an axis 22. A load beam 24 is connected to actuator arm 20 at a head mounting block 26. A gimbal 28 is connected to an end of load beam 24 and slider 12 is attached to gimbal 28. Slider 12 carries a transducing head (not shown in FIG. 1) for reading and/or writing data on concentric tracks 14 of disc 16. Disc 16 rotates around an axis 30 so that windage is encountered by glider 12 to keep it aloft a small distance above the surface of disc 16. FIG. 1 shows a disc drive having an upper and lower actuation assembly, with the lower actuation assembly being shown in phantom.

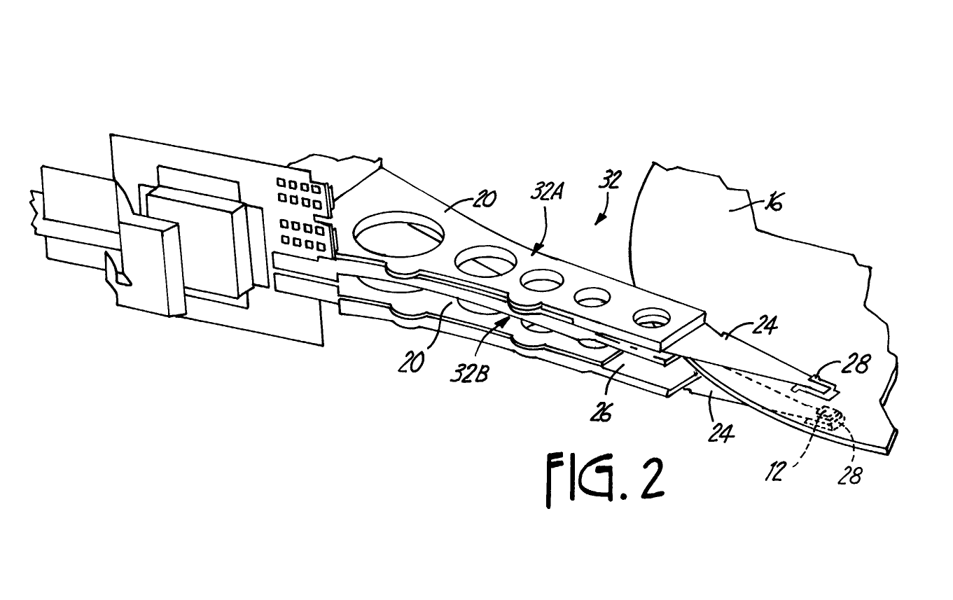

FIG. 2 is a perspective view of an actuation assembly 32 for positioning slider 12 over track 14 of disc 16. Actuation assembly 32 includes an upper assembly 32A and a lower assembly 32B that are identical. Both the upper assembly 32A and the lower assembly 32B have actuator arm 20 with load beam 24 connected to the actuator arm 20 at head mounting block 26. Gimbal 28 is connected to an end of load beam 24, and slider 12 is attached to gimbal 28. Slider 12 carried by upper assembly 32A reads and writes data from an upper surface of disc 16. Slider 12 located on lower assembly 32B reads and writes data from the lower surface of disc 16.

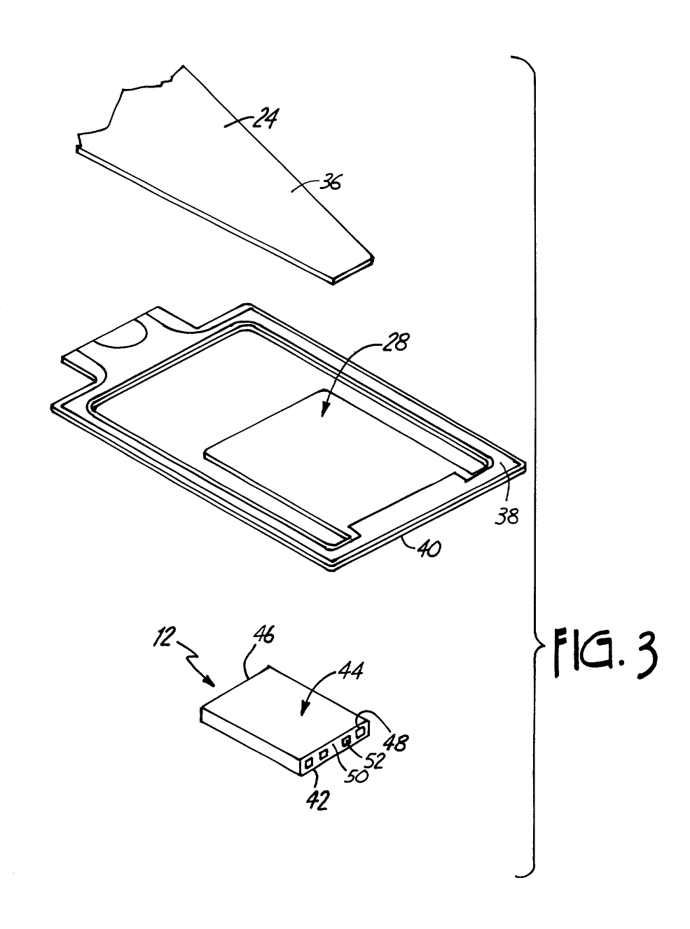

FIG. 3 is an exploded perspective view of the distal end portion of actuation assembly 32. Shown in FIG. 3, from top to bottom are load beam 24, gimbal 28 and slider 12. Load beam 24 has a dimple(not shown) formed on the bottom of load beam 24 at a distal end 36. Gimbal 28 is attached to load beam 24 relative to the dimple. A flex circuit material 38 is deposited on a slider opposing face 40 of gimbal 28. Slider 12 attaches to flex circuit material 38 and is positioned on gimbal 28 such that slider 12 balances on the dimple. Flex circuit material 38 provides a spring connection between slider 12 and load beam 24.

Slider 12 includes a disc opposing face 42 and a gimbal opposing face 44, which is attached to the slider opposing face 40 on the bottom surface of gimbal 28. Slider 12 has a leading edge 46 and a trailing edge 48. A forward face 50 is disposed on trailing edge 48 of slider 12. Forward face 50 extends between the disc opposing face 42 and gimbal opposing face 44. Slider bond pads 52 are formed on the forward face 50 of slider 12.

Gimbal 28 is configured to allow slider 12 to move in pitch and roll directions to compensate for fluctuations in the spinning surface of disc 16. Transducing head (not shown) is located on disc opposing face 42 of slider 12 proximate to trailing edge 48. In operation, load beam 24 and gimbal 28 carrying slider 12 move together as coarse positioning is performed by VCM 18 (FIG. 1) to rotate actuator arm 20 (FIG. 1).

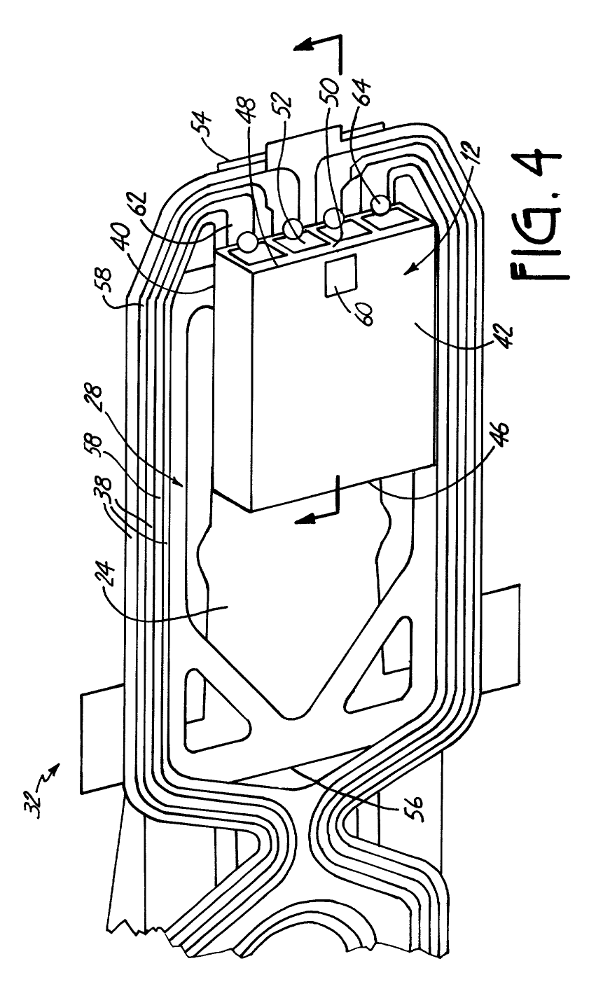

FIG. 4 is a perspective view of a disc opposing surface of the distal end portion of actuation assembly 32. Gimbal 28 is attached to load beam 24. Gimbal 28 has a front edge 54 and a rear edge 56. The rear edge 56 is attached to load beam 24. Flex circuit material 38 is disposed on slider opposing face 40 of gimbal 28. In the preferred embodiment of gimbal 28, flex circuit material 38 is disposed on gimbal 28 where the slider 12 attaches. Flex circuit material 38 generally travels along the underside of gimbal 28, load beam 24, and along the length of the actuator arm 20 all the way to circuitry located in another part of the disc drive (not shown). Flex circuit material 38 on slider opposing face 40 of gimbal 28 engages gimbal opposing face 44 (FIG. 3) of slider 12.

A trace layer 58 is disposed upon flex circuit material 38. Trace layer 58 completes a circuit connection between the electronic components of the disc drive (not shown) and a transducing head 60 carried by slider 12. Trace layer 58 travels along the underside of gimbal 28, load beam 24 and along the length of the actuator arm 20 on top of flex circuit material 38. Trace layer 58 is typically made of copper with gold plated on top of the copper layer. Each trace 58 ends at a flex on suspension (FOS) bond pad 62. In an exemplary embodiment there is at least one FOS bond pad 62 located on flex circuit material 38 for each slider bond pad 52 located on slider 12. FOS bond pads 62 are preferably located proximate to front edge 54 of gimbal 28 and forward of where slider 12 is attached to gimbal 28.

Slider 12 has a disc opposing face 42 (as viewed in FIG. 4 on the bottom of slider 12) and gimbal opposing face 44 (as viewed in FIG. 3 on the top of slider 12). Gimbal opposing face 44 is attached to gimbal 28 on slider opposing face 40 (as viewed in FIG. 4 on the bottom of gimbal 28) of gimbal 28. The transducing head 60 is located on disc opposing face 42 of slider 12. When slider 12 is attached to gimbal 28, forward face 50 of slider 12 is located proximate and substantially parallel to front edge 54 of gimbal 28. Thus, slider bond pads 52 located on forward face 50 of slider 12 are positioned proximate to FOS bond pads 62. An adhesive (not shown) is used to bond slider 12 to gimbal 28 with flex circuit material 38 between slider 12 and gimbal 28. During operation, when slider 12 flies above the disc, slider 12 typically possesses three primary degrees of movement, which are vertical motion, pitch and roll rotation.

When slider 12 is attached to gimbal 28, the slider bond pads 52 are aligned with FOS bond pads 62 of gimbal 28. A gold ball bond 64 is disposed on each slider bond pad 52. Ball bond 64 is bonded to slider bond pad 52 and its respective FOS bond pad 62. To create an electrical connection between slider 12 and trace layer 58. Ball bonds 64 act as an electrical conduit and complete the electrical connection between slider 12 and trace layer 58.

Head gimbal assembly (HGA) manufacturers have implemented automation as a means for reducing labor and overhead costs. For example, slider 12 maybe manufactured in bulk in an automated process. In addition, the ball bond interconnect design is used by most disc drive manufacturers because it is particularly suited for automated methods of electrically connecting the slider to gimbal 28. In addition to bonding, automation is also used to place slider 12 on flex circuit material 38 with respect to the dimple so that slider bond pads 52 are aligned with FOS bond pads 62.

The present invention slider allows for slider 12 to be produced in bulk and in an automated process, Additionally, the mechanical features of slider 12 allow slider 12 to be placed on gimbal 28 with respect to the dimple such that proper placement is achieved in repetitive processes even with nonrobust flex to gimbal being used. The mechanical features of slider 12 can be added during a batch process at the wafer level.

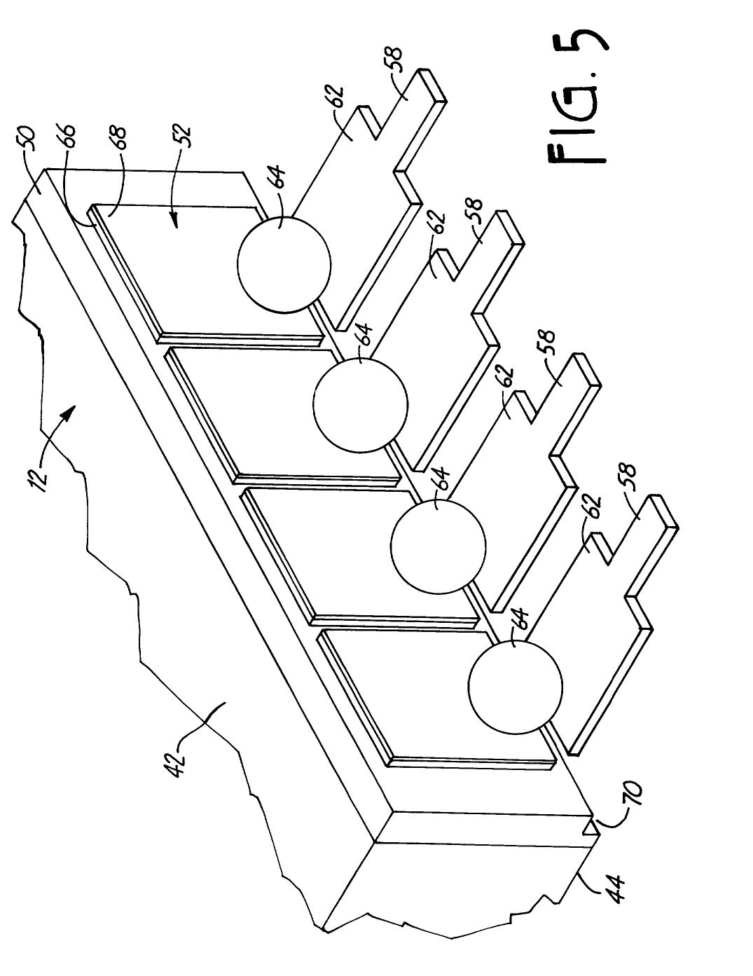

FIG. 5 is a greatly enlarged perspective view of slider 12 and bond pads 52 and 62 (the polyimide component of flex circuit material 38 is not shown for clarity). Forward face 50 of slider 12 is made of a different material than the rest of slider 12. Preferably, forward face 50 is made of alumina. Slider bond pads 52 formed on forward face 50 of slider 12 include a pad extension 66 and a gold bond pad 68. The pad extension 66 is formed on forward face 50 of slider 12. Gold bond pad 68 is attached to pad extension 66. A notch 70 is formed in forward face 50 adjacent to gimbal opposing face 44. Slider 12 is attached to gimbal 28 (FIG. 4) such that slider bond pads 52 are aligned with FOS bond pads 62. Gold ball bonds 64 are connected to slider bond pad 52 and its respective FOS bond pad 62 to provide an electric connection between the disc drive (not shown) and slider 12.

The present invention allows slider 12 to be placed on flex circuit material 38 using an automated process. Due to limitations in the manufacturing process, the location of the FOS bond pads may change from assembly to assembly, making precise positioning of the bond pads more difficult to predict. Extended slider bond pad 52 and notch 70 improve the likelihood of properly aligning slider bond pads 52 with FOS bond pads 62 by providing more room to compensate for potential misalignment.

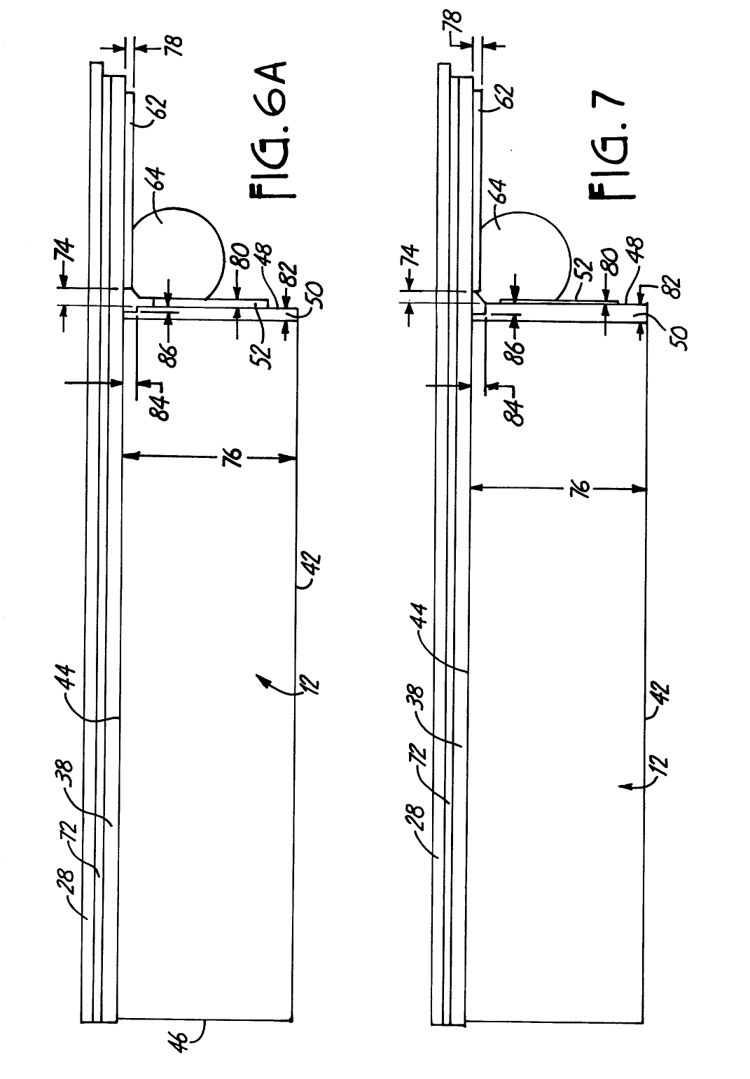

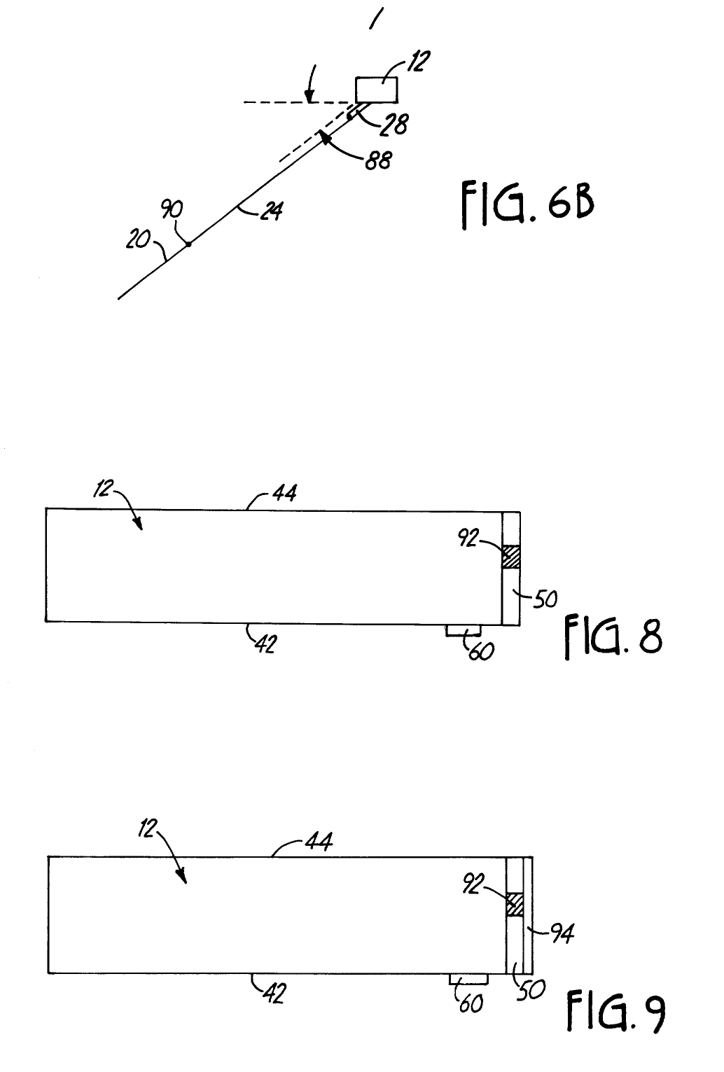

FIG. 6A is a cross-sectional view of one embodiment of slider 12 attached to flex circuit material 38. Flex circuit material 38 is disposed between slider 12 and gimbal 28. An adhesive 72 is used to attach flex circuit material 38 to gimbal 28. FOS bond pad 62 is an etched component of flex circuit material 38 proximate to front edge 54 of gimbal 28. Slider 12 is attached to gimbal 28 so that slider bond pad 52 is aligned with FOS bond pad 62. Gold ball bond 64 is connected to both slider bond pad 52 and FOS bond pad 62. Notch 70 is formed along forward face 50 of slider 12 adjacent to gimbal opposing face 44. A nominal gap 74 lies between forward face 50 and FOS bond pad 62 defining the nominal distance between the two.

Slider 12 has a slider height 76 equal to preferably about 300 microns. FOS bond pad 62 has a thickness 78 of preferably about 15 microns. Slider bond pad 52, including pad extension 66 and gold bond pad 68, has a thickness 80 of preferably about 15 microns. Forward face 50 has a thickness 82 of about 20 microns. Preferably notch 70 has a height 84 of about 25 microns and a depth 86 of about 40 microns. Height 84 of notch 70 is measured with respect to gimbal opposing face 44 of slider 12 and depth 86 is measured with respect to forward face 50 of slider 12. Preferably notch height 84 is larger than FOS bond pad thickness 78, thus slider 12 may overlap FOS bond pad 62 resulting in a negative nominal gap 74.

When slider 12 is attached to flex circuit material 38 disposed on gimbal 28, nominal gap 74 forms between forward face 50 and FOS bond pad 62. During alignment of glider 12 with respect to gimbal 28, the goal is to minimize nominal gap 74 without resulting in poor static attitude for slider 12. If nominal gap 74 is too large, a weak interconnect or no connection occurs between gold bond ball 64 and bond pads 52 and 62. A weak interconnect results in an increased potential for failure with the electrical connection between FOS bond pad 62 and slider bond pad 52. If nominal gap 74 is too small and slider 12 overlaps FOS bond pad 62, poor static attitude of slider 12 results. An angle 88 is formed between the gimbal opposing face 44 of slider 12 and a reference point 90 on load beam 24, preferably where head mounting block 26 contacts load beam 24 (as seen in FIG. 6B).

Angle 88 is the static attitude of slider 12 and relates to the pitch rotation of slider 12. Static attitude impacts fly height, take-off velocity and the reliability of the head disc interface. As angle 88 increases (i.e. static attitude increases), the ability to control the pitch of the slider decreases. That is, the increased pitch of slider 12 results in a non-planar surface and increases angle 88. The worse static attitude is (i.e. as angle 88 increases), the less control there is over the pitch rotation of slider 12. An overlap of slider 12 to FOS bond pad 62, results in more variation in the static attitude and thereby there is less control over slider 12. Furthermore, if the slider cannot be attached to the gimbal with the required static attitude, a post assembly adjustment must be done to change the static attitude at an additional cost and with detrimental effects to other suspension characteristics.

The extended slider bond pad 52, including pad extension 66, and notch 70 improve the likelihood of properly aligning slider bond pads 52 to FOS bond pads 62. Load beam 24 has distal end 36 with the dimple located at distal end 36 of load beam 24. Slider 12 is preferably placed on gimbal 28 relative to the dimple. Placing slider 12 on gimbal 28 with respect to the dimple results in improved performance of slider 12. Alternatively, slider 12 may be placed on flex circuit material 38 with respect to FOS bond pads 62. By placing slider 12 relative to FOS bond pads 62, a desired nominal gap 74 is guaranteed and a user does not have to worry about the effects of a too large or a too small gap. However, most HGA manufacturers position slider 12 relative to the dimple for better performance, in particular control of fly height, of slider 12.

The extended slider bond pad 52, utilizing pad extension 66 (not shown), and notch 70 provides margin when positioning slider 12 on gimbal 28 by allowing more room to compensate for potential mis-alignment. Notch 70 allows more alignment room for slider bond pads 52 with respect to FOS bond pads 62, including a small overlap, without increasing variation in the static attitude and thereby less control over slider 12 as seen in prior art sliders. Slider 12 is still placed on flex circuit material 38. By extending slider bond pad 52 and adding notch 70 to forward face 50 of slider 12, slider 12 once placed on flex circuit material 38 results in the desired nominal gap 74 and guarantees that nominal gap 74 is neither too large nor too small. The mechanical features of slider 12, in particular the pad extension 66 and notch 70 combine to provide a tolerance buffer which allows slider 12 to be positioned on gimbal 28 relative to the dimple to ensure proper bonding can occur and improves the likelihood of properly aligning slider bond pads 52 with FOS bond pads 62. The tolerance buffer provides room to compensate for potential misalignment.

In the embodiment shown in FIG. 6A, nominal gap 74 is preferably about 30 microns. Although, nominal gap 74 will vary from assembly to assembly, the maximum value of nominal gap 74 is preferably about 70 microns and the maximum overlap is about 10 microns, between slider 12 and FOS bond pad 62.

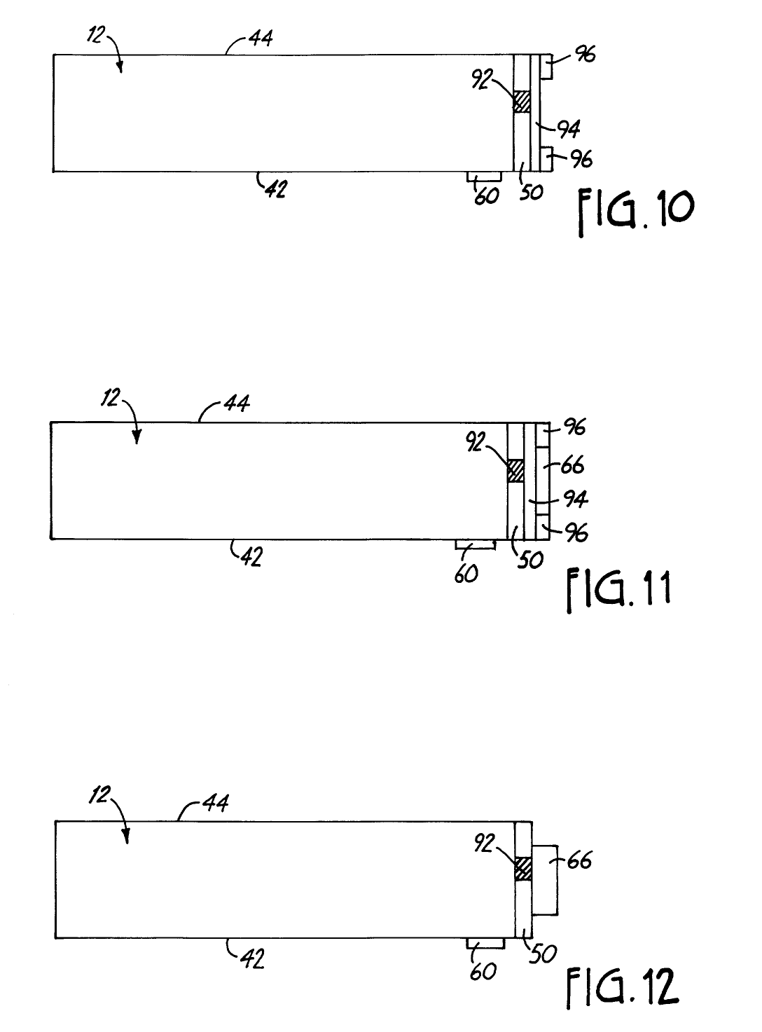

FIG. 7 shows a cross-sectional view of another embodiment of slider 12 attached to flex circuit material 38 disposed on gimbal 28. FIG. 7 illustrates that different embodiments of slider 12 having varying notch depths 86 and slider bond pad thickness 80 maybe used to achieve the desired nominal gap 74. For example, further embodiments of slider 12 may include only notch 70, only an extended slider bond pad 52, or both features to achieve proper alignment between slider bond pads 52 and FOS bond pads 62. These further embodiments still achieve the desired nominal gap 74 when slider 12 is mounted to flex circuit material 38 and proper alignment between slider bond pads 52 and FOS bond pads 62. Furthermore, different slider assemblies may be used with various gimbals and the desired range for nominal gap 74 will still be achieved.

In FIG. 7, the slider height 76 is the same at about 300 microns. The FOS bond pad thickness 78 is about 15 microns. The forward face thickness 82 is about 40 microns and slider bond pad thickness 80 is smaller at about five microns. Thus the combined thickness of forward face 50 and slider bond pad 52 is about 45 microns. Notch height 84 is about 25 microns and notch depth 86 is larger at about 40 microns. Notch depth 86 is increased and compensates for the smaller slider bond pad thickness 80. The combined thickness for the notch 70 and the slider bond pad 52 is about 45 microns. Nominal gap 74 of the embodiment shown in FIG. 7 is preferably about 14 microns. Preferably, the notch depth plus nominal gap dimensions are approximately equal to the notch depth plus nominal gap dimensions shown in FIG. 6A.

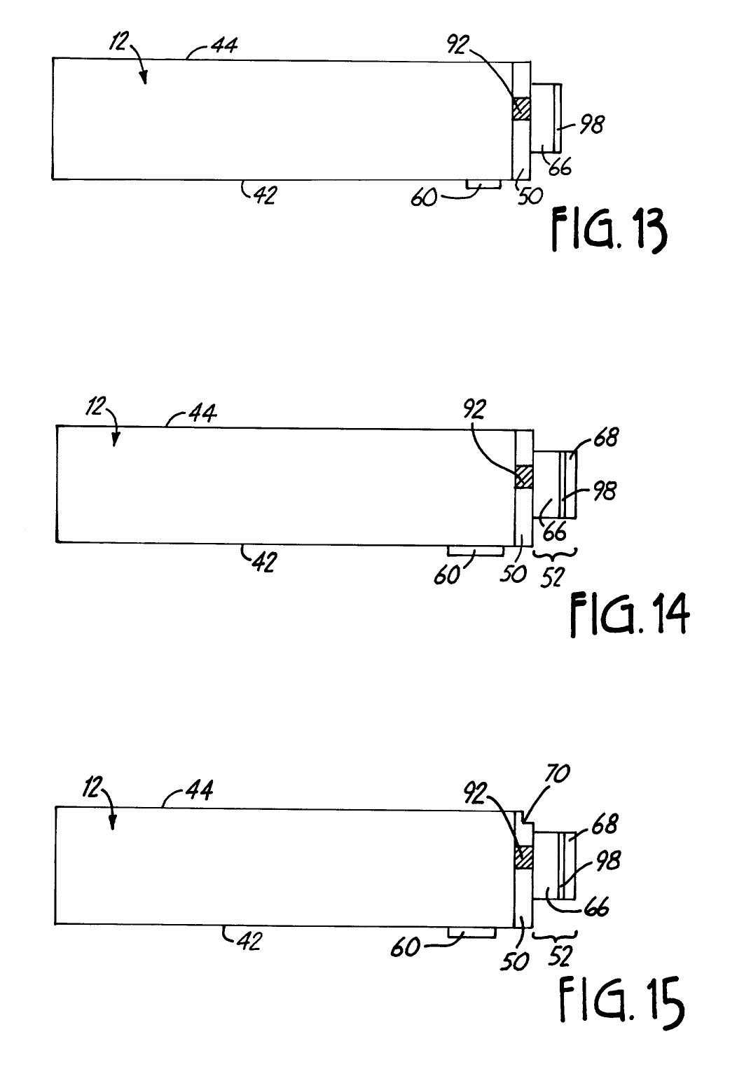

FIGS. 8 through 15 are sectional views of slider 12 taken along line A-A of FIG. 4 showing various stages of the manufacturing process for forming slider 12, in particular extended slider bond pad 52, Although slider 12 is formed at the wafer level in bulk, thereby resulting in lower cost and the ability to form multiple sliders, for simplicity FIGS. 8 through 15 show a single slider.

FIG. 8 shows slider 12 having forward face 50. Forward face 50 is the transducer circuitry covered by Alumnina. A copper stud 92 is formed in forward face 50 of slider 12. Copper stud 92 provides the connection between transducing head 60 (not shown) and slider bond pad 52 (not shown). Furthermore, copper stud 92 is a transition point between transducing head 60 and gold bond pads 68 (not shown).

FIG. 9 shows a first seedlayer 94 on top of copper stud 92 and forward face 50. First seedlayer 94 is deposited preferably by sputtering. First seedlayer 94 is typically made of chromium.

As shown in FIG. 10, a pad extension mask 96 is patterned upon first seedlayer 94. Pad extension mask 96 is typically made of photoresist. Pad extension mask 96 is used to pattern pad extension 66. Pad extension mask exposes the portions of first seedlayer 94 where pad extension 66 is to be plated and covers the remainder of first seedlayer 94.

Next, as shown in FIG. 11, pad extension 66 is formed in the exposed portions of pad extension mask 96, such as by a plating process. One suitable material for the pad 66 is nickel iron. Nickel iron is plated up within pad extension mask 96 to form pad extension 66. Nickel iron is preferred because of its plating capabilities. After pad extension 66 is plated, pad extension mask 96 and excess first seedlayer 94 is removed.

FIG. 12 shows slider 12 after removal of pad extension mask 96 and first seedlayer 94. Pad extension mask 96 is stripped away and forward face 50 remains. The means used to strip away pad extension mask 96 are preferably chemical. After stripping away pad extension mask 96, the excess seedlayer 94 is likewise removed, such as by an etching process.

As shown in FIG. 13, a second seedlayer 98 is deposited upon pad extension 66. Second seedlayer 98 is preferably deposited by sputtering. Second seedlayer 98 is preferably chromium. Chromium provides a good bond between pad extension 66 and gold bond pad 68.

As shown in FIG. 14, gold bond pad 68 is connected to pad extension 66. Gold bond pad 68 is used because the gold bonds well to gold bond ball 64 (FIG. 4). Furthermore, the gold provides a good electrical connection between trace layer 58 and slider 12. By using gold bond pad 68 in conjunction with pad extension 66, an extended slider bond pad 52 is provided without increasing manufacturing costs by using a thicker gold bond pad 68. The entire slider bond pad 52 could be made out of gold, but it is less expensive to plate a nickel iron pad extension 66.

As shown in FIG. 15, notch 70 is formed in forward face 50 adjacent gimbal opposing face 44 of slider 12. The notch is typically formed at the wafer level. There are three different preferred processes for forming notch 70 on slider 12. The first process requires using a grinding wheel to physically slice notch 70 out from forward face 50 of the slider 12. The second process users a laser to cut small strips along gimbal opposing face 44 of slider 12, thereby forming notch 70. The laser process creates a very defined scribe cut. The third process for forming notch 70 is a wafer etch process.

The present invention slider is used in an automated assembly process for attaching and aligning the slider to the flex circuit material on the gimbal. The ability to align the slider on the gimbal improves the performance of the actuation assembly. Several factors affect slider alignment, including flex circuit material alignment to the gimbal, slider alignment to the gimbal, the dimensional features of the gimbal, slider and flex circuit material, and the method of assembly. In the present invention, the extended slider bond pad and the notch formed on the slider aid in proper alignment of the slider to the FOS bond pads and reduce variation in the alignment. For example, the location of the FOS bond pads change from assembly to assembly, making their location difficult to predict. The present invention slider, incorporating the extended slider bond pad and the notch, provides proper alignment of the slider bond pads with the FOS bond pads even when the location of the FOS bond pads are unpredictable.

Proper alignment of the slider bond pads to the FOS bond pads ensures a desired nominal gap is formed between the two bond pads. Thus, the nominal gap is neither too large nor too small. Proper alignment of the slider bond pads with the FOS bond pads provides a strong interconnect between the slider bond pads and the FOS bond pads, results in a high slider to gimbal bond strength and provides a controlled static attitude of the slider.

The present invention permits the slider to be positioned on the flex circuit material disposed on the gimbal with respect to the dimple located on the load beam. By placing the slider on the flex circuit material with respect to the dimple, quality performance of the slider fly height is maintained.

Although the present invention has been described with reference to preferred embodiments, workers skilled in the art will recognize that changes may be made in form and detail without departing from the spirit and scope of the invention.

1. A slider supporting a transducing head proximate a rotating disc, the slider positioned on a gimbal having a slider opposing face with a flex circuit material on the slider opposing face and a flex on suspension (FOS) bond pad located on the flex circuit material, the slider comprising:
a slider body having a leading edge and a trailing edge, a forward face adjacent the trailing edge, and at least one slider bond pad located on the forward face; and
means for positioning the slider on the flex circuit material of the gimbal such that the slider bond pad is aligned with the FOS bond pad.

2. The slider of claim 1 wherein the means for positioning the slider on the flex circuit material comprises:
an extended bond pad on the forward face such that the extended bond pad is aligned with the FOS bond pad; and
a notch located along the forward face adjacent a gimbal opposing face of the slider wherein the notch and the extended bond pad provide a tolerance buffer.

3. The slider of claim 2 wherein the extended bond pad further comprises:
a copper stud formed on the forward face;
a pad extension plated upon the forward face; and
a gold bond pad mounted to the pad extension.

4. A method for aligning a slider on a gimbal wherein the gimbal includes a slider opposing face, the gimbal has a flex circuit material disposed on the slider opposing face and a flex on suspension (FOS) bond pad is disposed on the flex circuit material, the method comprising:
providing a slider having a gimbal opposing face and a disc opposing face bounded by a leading edge and a trailing edge, the slider having a forward face along the trailing edge extending between the gimbal opposing face and the disc opposing face;
forming an extended bond pad on the forward face of the slider;
forming a notch on the slider in the forward face adjacent the gimbal opposing face wherein the notch and the extended bond pad provide a tolerance buffer; and
placing the slider on the flex circuit material such that the extended bond pad is positioned relative the FOS bond pad to improve bond strength and static attitude.

5. The method of claim 4, and further comprising:
mounting the gimbal on the actuation assembly such that the slider is centered on a dimple formed on a load beam of the actuation assembly.

6. The method of claim 4 wherein forming the extended bond pad comprises:
forming a copper stud on the forward face of the slider body;
sputtering a first seedlayer on top of the copper stud and the forward face;
patterning a pad extension photoresist mask upon the first seedlayer;
plating nickel iron in the pad extension photoresist mask to form a pad extension;
stripping the pad extension photoresist mask;
sputtering a second seedlayer upon the pad extension; and
mounting a gold bond pad to the pad extension.

7. The method of claim 4 wherein forming the notch comprises slicing a portion of the forward face from the slider with a grinding wheel.

8. The method of claim 4 wherein forming the notch comprises cutting small strips along the gimbal opposing face of the slider using a laser.

9. The method of claim 4 wherein forming the notch comprises etching with a wafer etch process.

10. The method of claim 4 wherein the notch has a depth with respect to the forward face of about 40 microns.

11. The method of claim 4 wherein the notch has a height with respect to the gimbal opposing face of about 25 microns.

12. The method of claim 4 wherein the extended bond pad has a thickness between about 5 microns and about 15 microns.

13. The method of claim 4 wherein the extended bond pad is perpendicularly aligned with the FOS bond pad and there is a gap between the extended bond pad and the FOS bond pad.

14. The method of claim 4 wherein attaching the slider to the flex circuit further comprises ball bonding.

15. A slider supporting a transducing head proximate a rotating disc, the slider positioned on a gimbal having a slider opposing face coated with a flex circuit material and at least one flex on suspension (FOS) bond pad located on the flex circuit material, the slider comprising
a slider body having a gimbal opposing face and a disc opposing face;
a forward face extending between the gimbal opposing face and the disc opposing face;
an extended bond pad located on the forward face such that the extended bond pad is aligned with the FOS bond pad; and
a notch located along the forward face adjacent the gimbal opposing face wherein the notch and the extended bond pad provide a tolerance buffer for aligning the extended bond pad to the FOS bond pad.

16. The slider of claim 15 wherein a gold bond pad is mounted to the extended bond pad.

17. The slider of claim 15 wherein the extended bond pad further comprises:
a copper stud formed on the forward face;
a pad extension plated upon the forward face; and
a gold bond pad mounted to the pad extension.

18. The slider of claim 15 further comprising a ball bond between the extended bond pad and its respective FOS bond pad.

19. The slider of claim 15 wherein there is a gap between the extended bond pad and the FOS bond pad.

20. The slider of claim 15 wherein the notch is formed by slicing a portion of the forward face with a grinding wheel.

21. The slider of claim 15 wherein the notch is formed by cutting small strips along the gimbal opposing face using a laser.

22. The slider of claim 15 wherein the notch is formed using a wafer etch process.
